(19) United States
(12) Patent Application Publication
(10) Pub. No.: US 2009/0281273 A1
(43) Pub. Date: Nov. 12, 2009

(54) INSULATING POLYMERIC-MATERIAL COMPOSITION

(75) Inventor: Yasuyuki Kurata, Kanagawa (JP)

Correspondence Address: FOLEY AND LARDNER LLP;SUITE 500, 3000 K STREET NW, WASHINGTON, DC, 20007, US

(73) Assignee: MEIDENSHA CORPORATION

(21) Appl. No.: 12/440,511

(22) PCT Filed: Nov. 8, 2007
(86) PCT No.: PCT/JP2007/071697

§ 371 Date: Mar. 9, 2009

(30) Foreign Application Priority Data
Dec. 1, 2006 (JP) 2006-325143

(51) Int. Cl. C08G 65/04

(52) U.S. Cl. 528/332; 528/361

(57) ABSTRACT

There is provided an insulating polymeric-material composition that is superior in insulating performance and mechanical strength and exerts no adverse influence on the global environment even after discarded. This insulating polymeric-material composition is obtained by mixing lignin as a curing agent with an epoxidized linseed oil and then conducting a heating treatment to cure it. As the lignin, for example, one obtained by blasting a lignin raw material and then conducting an alcohol extraction is used. The epoxidized linseed oil and the lignin are mixed together in such a proportion that epoxy equivalent of the epoxidized linseed oil:hydroxyl equivalent of the lignin=1:1. In the composition, as a curing acceleration agent, for example, 2-ethyl-4-methylimidazole is added by 0.2-2.0 parts by weight relative to 100 parts by weight of the epoxidized linseed oil. Upon this, it is cured under a condition, for example, of a heating temperature of 150-170° C. and a heating time of 10-20 hours. In some cases, the heating temperature is set to be formed of two different temperature regions.

### TECHNICAL FIELD

The present invention relates to an insulating polymeric-material composition, particularly to a technology adapted to an insulating polymeric-material composition of electric power system that becomes high voltage and high temperature.

Hitherto, a composition obtained by curing a polymeric material, in which a thermosetting resin (a resin derived from petroleum as a starting material; epoxy resin, etc.) derived from a fossil fuel such as petroleum is a major component, for example, a product (a molded product; hereinafter referred to as a polymeric product) constituted by a composition obtained by molding a polymeric material has widely been known as a material adapted (for example, adapted by a direct exposure to the outdoors) to an insulating structure (for example, a section requiring insulation) of an voltage equipment (a high voltage equipment, etc.) equipped with a switching equipment, which is exemplified by breaker, disconnector, etc., in a casing.

Furthermore, along with the development and concentration of society in recent years, there has been a strong demand for a larger capacity, downsizing, high reliability (for example, mechanical properties (breakdown field characteristic, etc.), etc. of high voltage equipment, etc., and there has been a demand on the above-mentioned polymeric product to improve various characteristics.

In general, there is known a polymeric product, in which, for example, a heat-resistant epoxy resin having a glass transition temperature (hereinafter referred to as Tg) of at least 100° C. or a bisphenol A type epoxy resin that is relatively high in mechanical property (strength, etc.) is used as a main component of a polymeric material. In consideration of the case to dispose of the above-mentioned polymeric product (for example, disposal for reasons of lifetime, failure, etc.), the development of a polymeric product formed of a polymeric material having biodegradability (e.g., Patent Publication 1) is attempted.

In various technical fields, there has been conducted a trial to apply (for example, apply to printed wiring boards) a composition obtained by curing a polymeric material derived from biomass such as plant (e.g., Patent Publication 2). For example, in the case of using it under room temperature atmosphere, it is known to obtain a sufficient mechanical property, but the composition is one obtained by using an aldehyde as a curing agent. Since the mechanical property lowers under high temperature atmosphere, it was not applied to high voltage equipment.

As mentioned above, a polymeric product obtained by using a heat resistant epoxy resin having a glass transition temperature (hereinafter referred to as Tg) of at least 100° C. or the like as a main component of the polymeric material is hard and brittle. In the case of using it under an environment having a violent change of temperature, there is a fear that cracks tend to occur. Therefore, for example, there is conducted a trial of using a solid epoxy resin (for example, one that is −30° C. or lower in the result of a crack resistance test using a metal conductor) as a main component of a polymeric material or of improving crack resistance and the like by adding a large amount of filler to the polymeric material. However, viscosity of the polymeric material becomes extremely high. For example, in a molding operation or the like, it is not possible to secure a sufficient pot life (the minimum period of time necessary for an industrial work), and there is a fear that workability becomes worse.

Furthermore, the above-mentioned bisphenol A type epoxy resin is widely used as an industrial product, since it has a characteristic in which mechanical property is high. However, bisphenol A itself is regarded as one having hazardous property as an environmental hormone, and a fear is getting to start from the viewpoint of environment. There is a report that, if it is in a cured composition such as polymeric product, bisphenol A does almost not leak from the composition and has no hazardous property. Even if it is an extremely small amount (for example, ppm level or the amount less than that), it is a substance having hazardous property. Therefore, in case that the unreacted bisphenol A (low molecular weight component) exists in the composition, even in the composition as mentioned above, there is a possibility that the bisphenol A leaks into the air, and it is feared.

For example, in a facility for producing polymeric products, there is a fear to become under an atmosphere of high-concentration bisphenol A under a limited environment, such as the step of compounding bisphenol A type epoxy resin with various additives, etc. or the step of molding a polymeric material after the compounding step. Even if a full automation (automation in the production line of polymeric products) is intended in each step of the production facility, it becomes necessary to have a ventilation facility (a facility for purifying the air in the environment of usage) in each step. Therefore, there is a fear to cause the increase of the product cost.

In the case of disposing of the above-mentioned polymeric product (for example, disposing of that by the reason of lifetime, failure, etc.), it is possible to apply various disposal methods, but each has a problem shown in the following.

In the case of a polymeric product formed of a polymeric material containing as a main component a substance derived from a fossil fuel that is exemplified by the above-mentioned bisphenol A type epoxy resin, there was a fear with respect to the point that the application of a method of disposal by burning makes various hazardous substances and carbon dioxide emit in large amounts, thereby causing a fear of problems of environmental pollution, global warming, etc. On the other hand, it is possible to apply a method of simply subjecting the above-mentioned polymeric product to landfill disposal, but the final disposal site for the landfill disposal tends to decrease year by year. Regarding the remaining years of this final disposal site, it is around the 20^{th} year of Heisei era according to a rough calculation by the former Ministry of Health and Welfare. Based on the rough calculation of the former Ministry of Health and Welfare, the former Economic Planning Agency expects that waste disposal fee will rise dramatically around the 20^{th} year of Heisei era, thereby pushing down economic growth rate. From these, it is an urgent task to accelerate the use of a raw material that is easy to be dealt with when discarded.

### Patent Publication 1: Japanese Patent Application Publication 2002-358829

### Patent Publication 2: Japanese Patent Application Publication 2002-53699

### DISCLOSURE OF THE INVENTION

The present invention was made in view of the above-mentioned situation, and its object is to provide an insulating polymeric-material composition that is excellent in insulating performance and mechanical strength and exerts no adverse influence on the global environment even after discarded.

The invention according to claim 1 is an insulating polymeric-material composition characterized in that it is obtained by mixing a lignin as a curing agent with an epoxidized linseed oil, followed by a heating treatment to cure it.

In the invention according to claim 1, the invention according to claim 2 is characterized in that the lignin has been obtained by blasting a lignin source and then an alcohol extraction.

In the invention according to claim 1 or 2, the invention according to claim 3 is characterized in that the epoxy linseed oil and the lignin have been mixed together at a ratio of epoxy equivalent of the epoxy linseed oil hydroxy equivalent of the lignin=1:1.

In the invention according to claim 3, the invention according to claim 4 is characterized in that 0.2-2.0 parts by weight of 2-methyl-4-imidazole as a curing acceleration agent has been added to 100 parts by weight of the epoxy linseed oil, and a curing has been conducted under a condition of a heating temperature of 150-170° C. and a heating time of 10-20 hours.

In the invention according to claim 4, the invention according to claim 5 is characterized in that the heating temperature comprises two different temperature regions.

According to the above-mentioned invention, glass point transition temperature, volume resistivity and mechanical strength increase. Epoxidized linseed oil and lignin are non-petroleum raw materials not derived from fossil fuels, that is, derived from biomass. Therefore, they are biodegradable and carbon neutral. Thus, it is possible to adapt as an insulator a cured product derived from biomass resource like the present invention to industrial materials.

Therefore, according to the above-mentioned invention, it is possible to provide an insulating polymeric-material composition that is excellent in insulating performance and mechanical strength and exerts no adverse influence on the global environment even after discarded.

### BEST MODE FOR CONDUCTING THE INVENTION

Epoxy resin raw material, which can almost satisfies characteristics required as an industrial material, is derived from fossil fuel represented by petroleum. On the other hand, a raw material that is derived from biomass and makes a three-dimensional cross-linking becomes not only an alternative to epoxy resin raw material, but also solves a problem of environmental hormone. Even if it is subjected to disposal by burning, it is not regarded as one that newly generates carbon dioxide since it is carbon neutral.

An insulating polymeric-material composition of the present invention is focused on a resin formed of an epoxidized vegetable oil as an epoxy resin derived from biomass. That is, the insulating polymeric-material composition is an insulating polymeric-material composition obtained by mixing a lignin as a curing agent with a raw material derived from non-petroleum and then conducting a heating treatment to cure it. The raw material is an epoxidized linseed oil, and the lignin is obtained by blasting a lignin raw material and then alcohol extraction.

Similar to epoxidized soybean oil, epoxidized linseed oil has widely been used as a stabilizer in vinyl chloride resin, but it requires time for curing since it is poor in reactivity as compared with general industrial epoxy resins. Furthermore, it has not been examined as an insulating material since it is low in glass transition temperature characteristic and mechanical property.

Although an epoxy resin derived from biomass and lignin are used in an insulating polymeric-material composition of the present invention, it has been found to be able to provide an insulating polymeric material that is superior in insulation and also superior in mechanical strength at high temperature, as compared with insulating polymeric-material compositions formed of conventional industrial epoxy resins derived from fossil fuels such as petroleum. The above-mentioned epoxy resin and the lignin are carbon neutral for ecosystem, and they exert no adverse influence on the global environment even if an insulating polymeric-material composition according to the present invention is discarded.

Lignin, which is used as a curing agent, is a natural polymer having a structural unit of phenyl propane, which is contained in trees and plants, together with cellulose and semicellulose, and itself has no chemical activity under natural condition. In industry, it is partly used as a water reducing agent for cement or a dye dispersing agent, but it is almost subjected to burning. Furthermore, focusing on being a natural raw material, there is conducted a study of urethanation and phenolation as well as epoxidization, but it has not yet reached practical use. One of the reasons is the necessity to conduct a two-step, high-level chemical treatment of recovering lignin from trees and plants and then resinifying it.

In the above-mentioned insulating polymeric-material composition, a lignin itself recovered from trees and plants, which are lignin raw materials, is used as a curing agent. As the lignin raw materials, for example, trees and plants and more specifically Japanese larch are shown as examples. As a process for recovering lignin, it is possible to mention, for example, kraft process, saccharification process by acid and oxygen, steaming and blasting process, solvent process, etc. Depending on the treatment conditions, such as the type of additive, temperature, time, etc., molecular structure of the recovered lignin becomes completely different. In the above-mentioned composition, lignin is regarded as polyphenol, and a lignin recovered by blasting process is used in order to prevent chemical treatment to the utmost.

The above-mentioned blasting process is a process in which a lignin raw material is put into water of high-temperature and high-pressure, and the lignin is cracked by using temperature and time as factors and recovered as polyphenol. The high-temperature and high-pressure according to the blasting process refer to a condition less than critical point (374° C., 214 atm.) of water at most. The present invention is not limited by the treatment conditions of the blasting process, since the optimum solution can be found from the starting natural raw material, phenol equivalent, molecular weight, viscosity and cost. Of the recovered product containing lignin obtained by blasting, the nonaqueous portion is subjected to alcohol extraction, and then the alcohol component is evaporated to dryness. With this, lignin is obtained. The lignin obtained in such manner is mixed with the epoxidized linseed oil in such a proportion that epoxy equivalent:hydroxyl equivalent=1:1. Hydroxyl equivalent of the lignin is calculated by determination of active hydrogen. This mixing proportion fluctuates to become optimum by the ranking of properties that are required. Experientially, there is a fluctuation of 10%.

As a curing acceleration agent used for the insulating polymeric-material composition, organic oxides, amines, imidazoles, etc. are shown as examples. In the case of using imidazoles as the curing acceleration agent, the amount of the curing acceleration agent to be added is set, for example, at 0.2-2 parts by weight (phr) relative to 100 parts by weight (phr) of the epoxy resin. Upon this, the curing temperature is set, for example, at 150-170° C., and the curing time is set at 10-20 hours. In case that the curing acceleration agent is added by 1 part by weight, a two-step heating treatment is conducted, such as a heating treatment under lower than 150° C. (specifically around 100° C.) for several hours and then a heating treatment under 150° C. for several hours.

The raw material grade of the insulating polymeric-material composition is one of the selection examples. The raw materials of the insulating polymeric-material composition, the curing agent, and the curing acceleration agent are not limited to the maker grades.

The above-mentioned insulating polymeric-material composition of the present invention is directed to a cured product containing an epoxidized linseed oil and lignin, and it is not limited by the mixing ratio of the epoxidized linseed oil to the lignin and by the type and the amount of the curing acceleration agent to be added. The study of the curing temperature condition is just a control for making it close to properties appropriate for the object. Those cured under temperature and time conditions do not show completely different properties, and combinations of the curing temperature and the time, which are different from that of the report of the present invention, belong to the technical scope of the present invention. Furthermore, the reaction acceleration agent, the inhibitor, etc. as additives for improving operability and productivity, increasing reactivity and making it safe also belong to the technical scope of the invention, since properties of the cured products to be obtained do not have large differences.

In the following, Examples of the insulating polymeric-material composition of the present invention are described, but the technical scope of the present invention is not limited to the Examples.

Table 1 shows properties of an insulating polymeric-material composition according to Comparative Example based on a conventional technology and of insulating polymeric-material compositions according to Examples of the present invention. As the properties, there are shown glass point transition temperature, volume resistivity (based on JIS-K6911), and flexural strength (based on JIS-K7203). Flexural strength refers to a value at room temperature and 80° C.

Comparative Example shown in Table 1 refers to a composition obtained by mixing phthalic anhydride as a curing agent with a bisphenol A type epoxy resin, which is a raw material derived from petroleum, furthermore adding 0.2 parts by weight of 2-methyl-4-imidazole as a curing acceleration agent, and then curing it under a condition of a curing temperature of 170° C. and a curing time of 20 hours. As the bisphenol A type epoxy resin, CT200A made by Vantico Inc. was used. As the phthalic anhydride, HN2200 made by Hitachi Chemical Co., Ltd. was used. Glass transition temperature of this comparative example was 80° C. Volume resistivity was 8×10¹⁴ Ω·cm. Flexural strength was 120 MPa (room temperature) and 30 MPa (80° C.).

Example 1 refers to a composition obtained by mixing lignin as a curing agent with an epoxidized linseed oil, which is a raw material derived from non-petroleum, by a ratio of epoxy equivalent of the epoxy resin:hydroxy equivalent of the lignin=1:1, furthermore adding 0.2 parts by weight of 2-methyl-4-imidazole as a curing acceleration agent, and then curing it under a condition of a curing temperature of 170° C. and a curing time of 20 hours. As the epoxidized linseed oil, an epoxidized linseed oil made by Daicel Chemical Industries, Ltd. (Daimac L-500) was used. As the lignin, there was used a blasted, alcohol-extracted lignin obtained by subjecting a water-insoluble component of one, which had been obtained by blasting Japanese larch used as a lignin raw material, to alcohol extraction, and then evaporating the alcohol component. As the curing acceleration agent 2-ethyl-4-methylimidazole, 2E4MZ made by SHIKOKU CHEMICALS CORPORATION was used. Glass transition temperature of this example was 85° C. Volume resistivity was 10×10¹⁴ Ω·cm. Flexural strength was 135 MPa (room temperature) and 50 MPa (80° C.).

Example 2 refers to a composition obtained by the same materials and production process as those of Example 1, except in that 0.4 parts by weight of 2-methyl-4-imidazole as a curing acceleration agent was added to the epoxidized linseed oil, which is a raw material derived from non-petroleum. Glass transition temperature of this example was 90° C. Volume resistivity was 12×10¹⁴ Ω·cm. Flexural strength was 138 MPa (room temperature) and 60 MPa (80° C.).

Example 3 refers to a composition obtained by the same materials and production process as those of Example 1, except in that 0.8 parts by weight of 2-methyl-4-imidazole as a curing acceleration agent was added to the epoxidized linseed oil, which is a raw material derived from non-petroleum, and that the curing was conducted under a condition of a curing temperature of 150° C. and a curing time of 20 hours. Glass transition temperature of this example was 90° C. Volume resistivity was 15×10¹⁴ Ω·cm. Flexural strength was 140 MPa (room temperature) and 62 MPa (80° C.).

Example 4 refers to a composition obtained by the same materials and production process as those of Example 1, except in that 1.5 parts by weight of 2-methyl-4-imidazole as a curing acceleration agent was added to the epoxidized linseed oil, which is a raw material derived from non-petroleum, and that the curing was conducted under a condition of a curing temperature of 150° C. and a curing time of 20 hours. Glass transition temperature of this example was 95° C. Volume resistivity was 20×10¹⁴ Ω·cm. Flexural strength was 140 MPa (room temperature) and 65 MPa (80° C.).

Example 5 refers to a composition obtained by the same materials and production process as those of Example 1, except in that 2.0 parts by weight of 2-methyl-4-imidazole as a curing acceleration agent was added to the epoxidized linseed oil, which is a raw material derived from non-petroleum, and that the curing was conducted under a condition of a curing temperature of 150° C. and a curing time of 15 hours. Glass transition temperature of this example was 100° C. Volume resistivity was 20×10¹⁴ Ω·cm. Flexural strength was 140 MPa (room temperature) and 80 MPa (80° C.).

Example 6 refers to a composition obtained by the same materials and production process as those of Example 1, except in that 2.0 parts by weight of 2-methyl-4-imidazole as a curing acceleration agent was added to the epoxidized linseed oil, which is a raw material derived from non-petroleum, and that the curing was conducted under a condition of a curing temperature of 150° C. and a curing time of 10 hours. Glass transition temperature of this example was 95° C. Volume resistivity was 18×10¹⁴ Ω·cm. Flexural strength was 140 MPa (room temperature) and 68 MPa (80° C.).

Example 7 refers to a composition obtained by the same materials and production process as those of Example 1, except in that 1.0 part by weight of 2-methyl-4-imidazole as a curing acceleration agent was added to the epoxidized linseed oil, which is a raw material derived from non-petroleum, and that the curing was conducted under a two-step heating condition in which heating was conducted for 10 hours under a curing temperature of 100° C., followed by heating for 10 hours under a curing temperature of 150° C. Glass transition temperature of this example was 95° C. Volume resistivity was 15×10¹⁴ Ω·cm. Flexural strength was 138 MPa (room temperature) and 64 MPa (80° C.).

Example 8 refers to a composition obtained by the same materials and production process as those of Example 1, except in that 1.0 part by weight of 2-methyl-4-imidazole as a curing acceleration agent was added to the epoxidized linseed oil, which is a raw material derived from non-petroleum, and that the curing was conducted under a two-step heating condition in which heating was conducted for 10 hours under a curing temperature of 100° C., followed by taking it out of a mold and then heating for 10 hours under a curing temperature of 150° C. Glass transition temperature of this example was 90° C. Volume resistivity was 10×10¹⁴ Ω·cm. Flexural strength was 138 MPa (room temperature) and 60 MPa (80° C.).

As are clear from the values of glass transition temperature, volume resistivity and flexural strength of Examples 1-8 and Comparative Example, it is possible to confirm that the values of glass point transition temperature, volume resistivity and flexural strength of Examples 1-8 are higher than the values of Comparative Example (glass point transition temperature (80° C.), volume resistivity (8.0×10¹⁴ Ω·cm) and flexural strength (120 MPa (room temperature) and 30 MPa (80° C.))).

Therefore, as in Examples 1-8, it was shown that there is provided an insulating polymeric-material composition that is superior in insulation and mechanical strength, particularly strength under high temperature, by conducting a curing by mixing lignin, particularly a blasted, alcohol-extracted lignin, with an epoxidized linseed oil and then conducting a heating treatment. Even in a case in which various additives are suitably used besides the epoxidized linseed oil, lignin and imidazole, it is clear that effects similar to those of the present examples are obtained.

An insulating polymeric-material composition of the present invention was described based on the above examples. It is, however, clear to a person skilled in the art that the present invention can variously be transformed and modified in the scope of its technical idea. It is natural that such transformation and modification belong to the scope of the claims.

TABLE 1

| Sample | | Comp. Ex. | Example 1 | Example 2 | Example 3 | Example 4 |
|---|---|---|---|---|---|---|
| Resin | | B | E | E | E | E |
| Amount of Curing Acceleration | | 0.2 | 0.2 | 0.4 | 0.8 | 1.5 |
| Agent Added [Parts by Weight] | | | | | | |
| Curing Temp. 1 [° C.] | | 170 | 170 | 170 | 150 | 150 |
| Curing Time 1 [h] | | 20 | 20 | 20 | 20 | 20 |
| Curing Temp. 2 [° C.] | | — | — | — | — | — |
| Curing Time 2 [h] | | — | — | — | — | — |
| Tg (° C.) | | 80 | 85 | 90 | 90 | 95 |
| Volume Resistivity [Ω · cm] | | 8 × 10¹⁴ | 10 × 10¹⁴ | 12 × 10¹⁴ | 15 × 10¹⁴ | 20 × 10¹⁴ |
| Flexural Strength | Room Temp. | 120 | 135 | 138 | 140 | 140 |
| [MPa] | 80° C. | 30 | 50 | 60 | 62 | 65 |

| Sample | | Example 5 | Example 6 | Example 7 | Example 8 |
|---|---|---|---|---|---|
| Resin | | E | E | E | E |
| Amount of Curing Acceleration | | 2 | 2 | 1 | 1 |
| Agent Added [Parts by Weight] | | | | | |
| Curing Temp. 1 [° C.] | | 150 | 150 | 100 | 100 |
| Curing Time 1 [h] | | 15 | 10 | 10 | 10 |
| Curing Temp. 2 [° C.] | | — | — | 150 | 150 |
| Curing Time 2 [h] | | — | — | 10 | 10 |
| Tg (° C.) | | 100 | 95 | 95 | 90 |
| Volume Resistivity [Ω · cm] | | 20 × 10¹⁴ | 18 × 10¹⁴ | 15 × 10¹⁴ | 10 × 10¹⁴ |
| Flexural Strength | Room Temp. | 145 | 140 | 138 | 138 |
| [MPa] | 80° C. | 68 | 68 | 64 | 60 |

E: epoxidized linseed oil
B: bisphenol A type epoxy resin

1. An insulating polymeric-material composition of an electric power system, said insulating polymeric-material composition being characterized in that it is obtained by a process comprising the steps of:
a) mixing a lignin as a curing agent with an epoxidized linseed oil to prepare a mixture; and
b) conducting a heating treatment on the mixture to cure the mixture.

2. An insulating polymeric-material composition according to claim 1, which is characterized in that the lignin is one obtained by blasting a lignin raw material and then conducting an alcohol extraction.

3. An insulating polymeric-material composition according to claim 1, which is characterized in that the epoxidized linseed oil and the lignin are mixed together in such a proportion that epoxy equivalent of the epoxidized linseed oil:hydroxyl equivalent of the lignin=1:1.

4. An insulating polymeric-material composition according to claim 3, which is characterized in that 0.2-2.0 parts by weight of 2 methyl 4 imidazole 2-ethyl-4-methylimidazole as a curing acceleration agent has been is added to 100 parts by weight of the epoxidized linseed oil, and then a curing has been is conducted in a condition of a heating temperature of 150-170° C. and a heating time of 10-20 hours.

5. An insulating polymeric-material composition according to claim 4, which is characterized in that the heating temperature comprises two different temperature regions.
